(19) United States
(12) Patent Application Publication
(10) Pub. No.: US 2024/0144026 A1
(43) Pub. Date: May 2, 2024

(54) AUTOMATED TUNING OF HYPERPARAMETERS BASED ON RANKINGS IN A FEDERATED LEARNING ENVIRONMENT

(71) Applicant: International Business Machines Corporation, Armonk, NY (US)

(72) Inventors: Yi Zhou, San Jose, CA (US); Parikshit Ram, Atlanta, GA (US); Theodoros Salonidis, Wayne, PA (US); Nathalie Baracaldo Angel, San Jose, CA (US); Horst Cornelius Samulowitz, Armonk, NY (US); Heiko H. Ludwig, San Francisco, CA (US)

(21) Appl. No.: 18/115,596

(22) Filed: Feb. 28, 2023

(30) Foreign Application Priority Data
Oct. 26, 2022 (GR) 20220100875

(51) Int. Cl. G06N 3/098

(52) U.S. Cl. CPC G06N 3/098

(57) ABSTRACT

A computer-implemented method, according to one approach, includes issuing a hyperparameter optimization (HPO) query to a plurality of computing devices. HPO results are received from the plurality of computing devices, and the HPO results include a set of hyperparameter (HP)/rank value pairs. The method further includes computing, based on the set of HP/rank value pairs, a global set of HPs from the HPO results for federated learning (FL) training. An indication of the global set of HPs is output to the plurality of computing devices. A computer program product, according to another approach, includes a computer readable storage medium having program instructions embodied therewith. The program instructions are readable and/or executable by a computer to cause the computer to perform the foregoing method.

### BACKGROUND

The present invention relates to machine learning models, and more specifically, this invention relates to auto-tuning hyperparameters based on rankings in a federated learning (FL) environment.

Machine learning is a popular means of decision making and is used in many different fields today. FL is a popular means of training machine learning models that trains a predetermined algorithm typically at a plurality of different sites that include computing devices. One goal of FL includes collaboratively training a machine learning model without sharing and/or revealing training data. Generally speaking, an amount of data that is included in such training is proportional to a relative quality of the models, e.g., relatively more data translates to relatively better quality models. However, there are downsides to including some types of data into the process of training a machine learning model. For example, including some local data such as personal data and legislation data, e.g., internet of things (IoT) data, smartphone data, General Data Protection Regulation (GDPR) data, HIPAA data,

Health Insurance Portability and Accountability Act (HIPAA) data, etc., in a training process may violate data privacy laws and/or subject an associated computing device's local data to identity theft. Furthermore, including business data, e.g., cable company business strategies, banking secrets, business models, customer lists, etc., in a training process may enable competitors to gain access to such data. Some other types of data may be subject to connectivity constraints, e.g., where communication with a computing device on a different planet may take days to be performed, and therefore not be realistically feasible to incorporate into a training process. There is therefore a need to train a machine learning model within an FL environment without compromising the privacy of local data of a computing device.

### SUMMARY

A computer-implemented method, according to one approach, includes issuing a hyperparameter optimization (HPO) query to a plurality of computing devices. HPO results are received from the plurality of computing devices, and the HPO results include a set of hyperparameter (HP)/rank value pairs. There are benefits enabled as a result of the HP/rank value pairs including rankings of hyperparameters rather than local value data of the computing devices. For example, basing the value pairs on HP rankings rather than local data ensures that such local data, e.g., such as loss data, is not shared in a setting that compromises the security and privacy of such data. Accordingly, outside actors, e.g., such as a competitor capable of reverse engineering the data, a malicious actor capable of using the data to gain unauthorized access to the computing device, etc., may be able to intercept such local data if such data is otherwise shared outside of the local setting of the computing devices. Locally retaining and concealing local data, the HP/rank value pairs also outperform default HP performance that is based on FL implementations where local data is made available outside of the computing devices. The method also includes computing, based on the set of HP/rank value pairs, a global set of HPs from the HPO results for federated learning (FL) training. An indication of the global set of HPs is output to the plurality of computing devices. The output indication of the global set of HPs to the computing devices enables HPs determined to be optimal to be utilized on the computing devices.

The method also includes orchestrating the FL training with the global set of HPs. By orchestrating the FL training using the global set of HPs, HPs determined to cause relatively less loss are prioritized and used instead of using other HPs that would otherwise cause relatively more losses. Performance of the computing devices is relatively improved as a result.

The computation, based on the set of HP/rank value pairs, of the global set of HPs from the HPO results for federated learning (FL) training includes generating a unified loss surface using the HP/rank value pairs of the received HPO results. Furthermore, a minimizer of a predetermined unified loss surface function is the global set of HPs. By ensuring a minimizer of the predetermined unified loss surface function is the global set of HPs, the global set of HPs are ensured to include HPs that benefit performance of FL training with respect to minimizing losses.

A computer program product, according to another approach, includes a computer readable storage medium having program instructions embodied therewith. The program instructions are readable and/or executable by a computer to cause the computer to perform the foregoing method.

A system, according to another approach, includes a processor, and logic integrated with the processor, executable by the processor, or integrated with and executable by the processor. The logic is configured to perform the foregoing method.

Other aspects and approaches of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach of the present invention.

FIG. 2 illustrates a tiered data storage system in accordance with one aspect of the present invention.

FIG. 3 illustrates a flowchart of a method for performing automated hyperparameter tuning at an aggregator, in accordance with one aspect of the present invention.

FIG. 4 illustrates a flowchart of a method for performing automated hyperparameter tuning at a party, in accordance with one aspect of the present invention.

FIG. 5 illustrates an exemplary federated learning (FL) environment, in accordance with one aspect of the present invention.

FIG. 6 illustrates a flowchart of a method, in accordance with one aspect of the present invention.

FIG. 7 illustrates a flowchart of a method, in accordance with one aspect of the present invention.

FIG. 8 illustrates a FL environment, in accordance with one aspect of the present invention.

FIGS. 9A-9D depict tables of preliminary experimental results, in accordance with various approaches of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for auto-tuning hyperparameters based on rankings in a federated learning (FL) environment.

In one general approach, a computer-implemented method includes issuing a hyperparameter optimization (HPO) query to a plurality of computing devices. HPO results are received from the plurality of computing devices, and the HPO results include a set of hyperparameter (HP)/rank value pairs. The method further includes computing, based on the set of HP/rank value pairs, a global set of HPs from the HPO results for federated learning (FL) training. An indication of the global set of HPs is output to the plurality of computing devices.

In another general approach, a computer program product includes a computer readable storage medium having program instructions embodied therewith. The program instructions are readable and/or executable by a computer to cause the computer to perform the foregoing method.

In another general approach, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as inventive code in block 200 for auto-tuning hyperparameters based on rankings in a federated learning (FL) environment. In addition to block 200, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

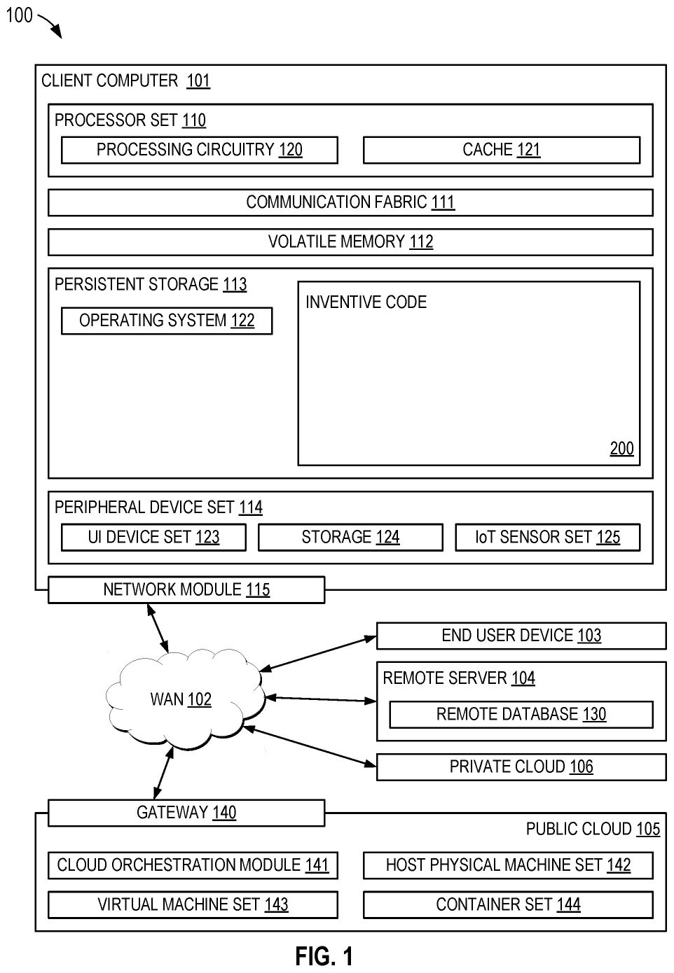

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

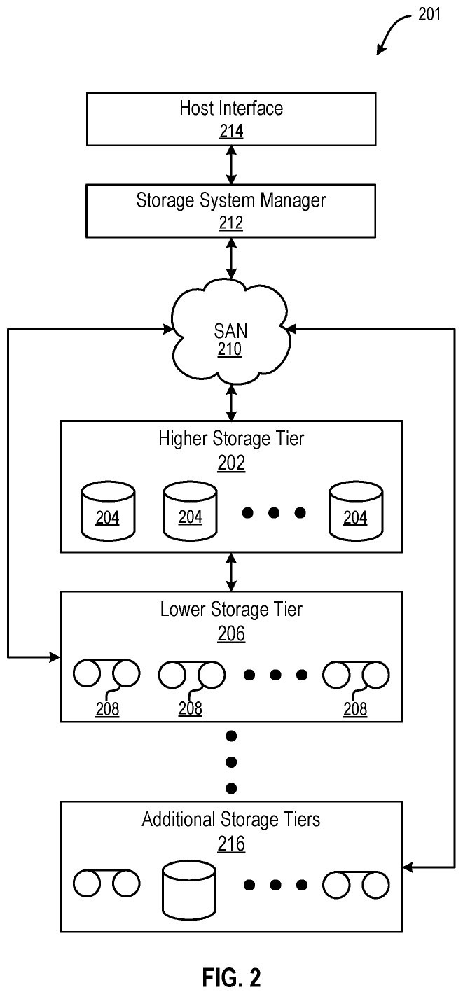

Now referring to FIG. 2, a storage system 201 is shown according to one approach. Note that some of the elements shown in FIG. 2 may be implemented as hardware and/or software, according to various approaches. The storage system 201 may include a storage system manager 212 for communicating with a plurality of media and/or drives on at least one higher storage tier storage tier s 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 201. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a storage area network (SAN), as shown in FIG. 2, or some other suitable network type. The storage system manager 212 may also communicate with one or more host systems (not shown) through a host interface 214, which may or may not be a part of the storage system manager 212. The storage system manager 212 and/or any other component of the storage system 201 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more approaches, the storage system 201 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the approaches presented herein.

According to some approaches, the storage system (such as 201) may include logic configured to receive a request to open a data set, logic configured to determine if the requested data set is stored to a lower storage tier 206 of a tiered data storage system 201 in multiple associated portions, logic configured to move each associated portion of the requested data set to a higher storage tier 202 of the tiered data storage system 201, and logic configured to assemble the requested data set on the higher storage tier 202 of the tiered data storage system 201 from the associated portions.

Of course, this logic may be implemented as a method on any device and/or system or as a computer program product, according to various approaches.

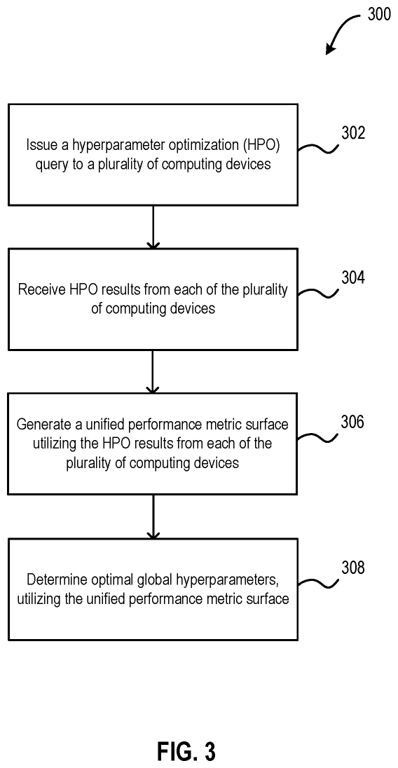

Now referring to FIG. 3, a flowchart of a method 300 is shown according to one approach. The method 300 may be performed in accordance with the present invention in any of the environments depicted in FIGS. 1-9D, among others, in various approaches. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various aspects, the method 300 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3, method 300 may initiate with operation 302, where a hyperparameter optimization (HPO) query is issued to a plurality of computing devices. In one approach, each of the plurality of computing devices may include an independent hardware computing device (e.g., a server, etc.). In another approach, each of the plurality of computing devices may include a node within a distributed computing system.

Additionally, in one approach, each of the plurality of computing devices may be logically and physically separate from the other computing devices. In another approach, each of the plurality of computing devices may have its own private data set (e.g., training data). For example, the private data set of a computing device may only be accessed by that computing device, and other computing devices within the plurality of computing devices may not have access to the data set of another computing device.

Further, in one approach, each of the plurality of computing devices may include a party within an FL environment. For example, the FL environment may include an aggregator in communication with each of the plurality of computing devices. In another example, the HPO query may be sent by the aggregator to each of the plurality of computing devices. In yet another example, the aggregator may include a central node tasked with training a global model (e.g., a machine learning model such as a neural network, a decision tree, etc.). In still another example, each of the plurality of computing devices may have a corresponding local model separate from the global model.

Further still, in one approach, the HPO query may include a request to perform a plurality of HPO operations at each of the plurality of computing devices, and a performance metric to be optimized. For example, each of the plurality of computing devices may perform the plurality of HPO operations in parallel, separately from the other computing devices. In another example, the performance metric of the HPO query may include one or more of predictive machine learning metrics including absolute or relative accuracy or loss and resource metrics including runtime and memory utilization.

Also, method 300 may proceed with operation 304, where HPO results are received from each of the plurality of computing devices. In one approach, the HPO results may include the results of running a plurality of HPO operations on each of the plurality of computing devices. In another approach, the HPO results may include a set of hyperparameter (HP)/performance metric pairs. For example, the performance metric may include any user-specified predictive performance metric, such as loss, accuracy, F1, balanced accuracy, etc. In yet another approach, hyperparameters may include parameters used within a machine learning model during a training of the model.

In addition, in one approach, each of the plurality of computing devices, each HP/performance metric pair may include a hyperparameter and a corresponding loss value generated via the HPO operations utilizing that hyperparameter within a machine learning model of the computing device. In another approach, the HPO results may be received by an aggregator from each of the plurality of computing devices.

Furthermore, method 300 may proceed with operation 306, where a unified performance metric surface is generated utilizing the HPO results from each of the plurality of computing devices. In one approach, a union of the HPO results from each of the plurality of computing devices may be created. For example, the union may combine all of the received HPO results (e.g., HP/performance metric pairs from all of the computing devices) into a single set of HP/performance metric pairs.

Further still, in one approach, the unified performance metric surface may include a trained machine learning model. In another approach, the unified performance metric surface may be trained utilizing the unioned/combined set of HP/performance metric value pairs. For example, the features of the machine learning model may include the hyperparameters, and the performance metric values may include the targets of the regression model. In another example, the machine learning model may be trained by mapping hyperparameters to single scalar values. In another approach, the aggregator may perform the union of the HPO results, and may generate the unified performance metric surface.

Also, method 300 may proceed with operation 308, where optimal global hyperparameters are determined utilizing the unified performance metric surface. In one approach, for each hyperparameter value in the union of the HPO results, a prediction may be determined utilizing the trained unified performance metric surface to determine a loss value for that hyperparameter. In another approach, hyperparameters that produce an optimal performance metric (e.g., a lowest loss when compared to other hyperparameters, a loss below a predetermined threshold, etc.) may be selected as optimal global hyperparameters.

Additionally, in one approach, the aggregator may determine the optimal global hyperparameters. In another approach, the optimal global hyperparameters may be sent to each of the plurality of computing devices. For example, each of the plurality of computing devices may determine a local loss surface utilizing their local HPO results. In another example, each of the plurality of computing devices may determine optimal local hyperparameters utilizing the local loss surface and the optimal global hyperparameters.

Further, in one approach, the optimal global hyperparameters may be used to determine a global model structure and/or train the global model. For example, the optimal global hyperparameters may be applied to a global model, and the global model may be trained utilizing FL. In another example, an aggregator managing the training of a global model may be in communication with a plurality of computing devices (e.g., parties). In another approach, the aggregator may train a global model, while each of the plurality of computing devices may train a local model separate from the global model. In yet another approach, the aggregator may apply the optimal global hyperparameters to the global model.

Further still, in one approach, the aggregator may send queries to each of the parties. For example, the queries may request local information from each of the parties. In another example, for a neural network implementation, the queries may request gradients that are evaluated on a local data set with current model weights for local models, etc. In yet another example, for a decision tree implementation, the queries may request a number of points that satisfy a certain condition (e.g., a value range, a predetermined label value, etc.). In another approach, the aggregator may receive replies from the parties in response to the queries, may aggregate the replies, may generate results based on the aggregation, and may update the global model based on the results.

In this way, optimal hyperparameters may be dynamically determined for the global model. This may reduce an amount of processing necessary to fine-tune the global model during FL, which may improve a performance of computing hardware performing the FL (e.g., the aggregator, etc.).

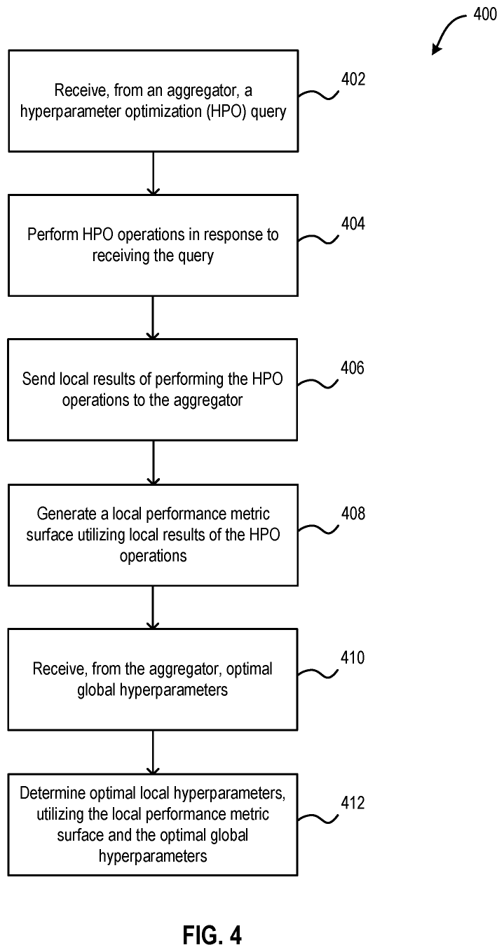

Now referring to FIG. 4, a flowchart of a method 400 is shown according to one approach. The method 400 may be performed in accordance with the present invention in any of the environments depicted in FIGS. 1-9D, among others, in various approaches. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various aspects, the method 400 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, where a hyperparameter optimization (HPO) query is received from an aggregator. In one approach, the HPO query may be received at an independent hardware computing device (e.g., a server, etc.). In another approach, the computing device may include a node within a distributed computing system. In yet another approach, the computing device may include a party within an FL environment. In still another approach, the HPO query may include a request to perform a plurality of HPO operations at the computing device.

Additionally, method 400 may proceed with operation 404, where HPO operations are performed in response to receiving the query. In one approach, performing the HPO operations may include generating different values for different hyperparameters at the computing device. In another approach, performing the HPO operations may include training a local model at the computing device, utilizing a local training data set and the generated hyperparameter values.

For example, the computing device may include one of a plurality of separate computing devices within an FL environment. In another example, the computing device may have its own local training data set that is not accessible by other computing devices within the federated learning environment.

Further, in one approach, performing the HPO operations may include evaluating, at the computing device, the trained local model on local test data to compute a loss value for each of the generated hyperparameter values. In another approach, the results of performing the HPO operations may include a plurality of local hyperparameter (HP)/performance metric pairs. For example, each HP/performance metric pair may indicate a hyperparameter used within the local model, and a corresponding loss value generated by the local model with that hyperparameter.

Further still, method 400 may proceed with operation 406, where local results of performing the HPO operations are sent to the aggregator. In one approach, the computing device may send the computed local HP/performance metric pairs to the aggregator that sent the HPO query.

Also, method 400 may proceed with operation 408, where a local performance metric surface is generated utilizing local results of the HPO operations. In one approach, the local performance metric surface may include a trained machine learning regression model. In another approach, the local performance metric surface may be trained utilizing the computed HP/performance metric pairs. For example, the features of the regression model may include the hyperparameters, and the performance metric values may include the targets of the regression model. In another example, the regression model may be trained by mapping hyperparameters to single scalar values. In another approach, the computing device may generate the local performance metric surface.

In addition, method 400 may proceed with operation 410, where optimal global hyperparameters are received from the aggregator. In one approach, the optimal global hyperparameters may be generated by the aggregator utilizing a unified performance metric surface and the HPO results from each of a plurality of computing devices.

Furthermore, method 400 may proceed with operation 412, where optimal local hyperparameters are determined utilizing the local performance metric surface and the optimal global hyperparameters. In one approach, for each hyperparameter value in the local HP/performance metric pairs, a prediction may be determined utilizing the trained local performance metric surface to determine a loss value for that hyperparameter. In another approach, hyperparameters that produce a minimum loss (e.g., a lowest loss when compared to other hyperparameters, a loss below a predetermined threshold, etc.) may be selected as optimal local hyperparameters.

Further still, in one approach, the optimal local hyperparameters and the optimal global hyperparameters may be applied to the local model, and the local model may be trained as part of the FL process.

In this way, optimal hyperparameters may be dynamically determined for the local model. This may reduce an amount of processing necessary to fine-tune the local model during FL, which may improve a performance of computing hardware performing the FL (e.g., the hardware computing device, etc.).

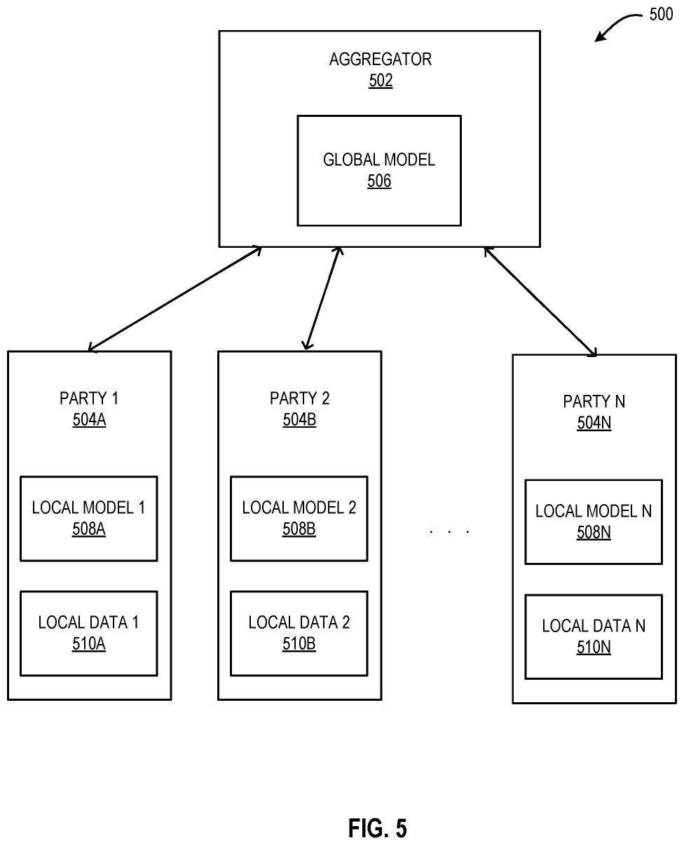

FIG. 5 illustrates an exemplary FL environment 500, according to one exemplary approach. As shown, the FL environment 500 includes an aggregator 502 in communication with a plurality of parties 504A-N. The aggregator 502 manages a global model 506, while each of the parties 504A-N manages a corresponding local model 508A-N. Each of the parties 504A-N has its own set of local data, which is not accessible by any of the other parties 504A-N or the aggregator 502.

In one approach, the aggregator 502 may issue a hyperparameter optimization (HPO) query to each of the plurality of parties 504A-N. In response to receiving the HPO query, each of the parties 504A-N may perform HPO operations. For example, each of the parties 504A-N may determine a plurality of local hyperparameter (HP)/loss pairs. In another approach, each of the parties 504A-N may perform the HPO operations separately from the other parties 504A-N. In yet another approach, the parties 504A-N may perform the HPO operations in parallel.

Additionally, in one approach, each of the parties 504A-N may send the results of the HPO operations (e.g., the local hyperparameter (HP)/loss pairs) to the aggregator 502. The aggregator 502 may create a union of the results, and may generate a unified loss surface utilizing the union. The aggregator 502 may then determine optimal global hyperparameters utilizing the unified loss surface, and may send the optimal global hyperparameters to each of the parties 504A-N.

Further, in one approach, before, during, or after the determination of optimal global hyperparameters by the aggregator 502, each of the parties 504A-N may generate, in parallel with each other, a local loss surface utilizing local results of the HPO operations. After receiving the optimal global hyperparameters from the aggregator 502, each of the parties 504A-N may determine optimal local hyperparameters, utilizing their local loss surface and the optimal global hyperparameters.

Further still, in one approach, each of the parties 504A-N may apply their optimal local hyperparameters and optimal global hyperparameters to their corresponding local model 508A-N. In another approach, the aggregator 502 may apply the optimal global hyperparameters to its global model 506. After optimal hyperparameters have been applied, the aggregator 502 may initiate FL.

For example, the aggregator 502 may send queries to each of the parties 504A-N requesting local information from each of the parties. The parties 504A-N may each generate a reply utilizing their corresponding local data 510A-N, and may send the reply to the aggregator 502. The aggregator 502 may receive and aggregate the replies, and may generate results based on the aggregation, where the results are used to update the global model 506.

In this way, optimal hyperparameters may be dynamically determined for the global model 506 and each of the local models 508A-N. This may minimize an amount of tuning that is performed for the global model 506 and each of the local models 508A-N, utilizing a single round of communication between the global model 506 and each of the local models 508A-N (instead of multiple rounds of communication in previous manual methods). This may reduce an amount of computing and communications bandwidth used by both the global model 506 and each of the local models 508A-N during the hyperparameter tuning process, which may improve a performance of the global model 506 and each of the local models 508A-N (each of which may be implemented in computing hardware).

### A Method to Auto-Tune Hyperparameters in FL Systems

FL includes the collaborative training of a machine learning model without sharing/revealing training data. An FL environment includes an aggregator that monitors the FL process. The aggregator issues queries to parties, collects responses from the parties, and aggregates the collected responses to update a global model.

Exemplary queries issued by the aggregator to learn the global predictive model include queries for gradients as well as parameters, given a current weight (model parameter). Additional queries may ask for information about a specific label (class), such as counts. Additionally, parties within the FL environment include participants who respond to the queries based on their local databases.

The selection of hyperparameters is very important in an FL system, especially where there might be data distribution heterogeneity among parties. In response, a systematic approach is provided to perform hyperparameter tuning in an FL system which ensures the performance of the final global model without compromising local data privacy among the parties under both IID and non-IID settings. In some approaches herein, hyperparameters related to the aggregation/fusion step are not optimized, for example, party selection strategy and/or party reply quorum, etc.

In one approach, a method to perform hyperparameter tuning in FL settings may include querying, by an aggregator, parties to perform hyperparameter optimization (HPO). Additionally, parties receiving the HPO query use their local dataset and the current model to run HPO to generate a set of features/loss pairs, and the set is sent to the aggregator.

Further, the aggregator uses the collected features/loss pairs to select the best global hyperparameters for FL training, and shares these best global hyperparameters with all parties. The parties use the features/loss pairs to select the best local hyperparameters for local training with the received best global hyperparameters. The aggregator orchestrates the FL training with the selected hyperparameters.

Further still, the aggregator may generate a unified loss surface using the union of all global hyperparameter/loss pairs collected from all the parties, and may select the best global hyperparameters via minimizing the unified loss surface function. Also, each party generates a per-party loss surface using the respected local hyperparameter/loss pairs and the selected global hyperparameters, and selects the minimizer of the per-party loss surfaces as the final local hyperparameters.

In addition, the loss surface is generated by training a machine learning model with the hyperparameters as the inputs and the corresponding loss as the targets. Furthermore, the HPO algorithms may include a random search algorithm, a Bayesian algorithm, etc.

### Single-Shot Hyper-Parameter Optimization for FL

Traditional machine learning (ML) approaches require training data to be gathered at a central location where the learning algorithm runs. In real world scenarios, however, training data is often subject to privacy or regulatory constraints restricting the way data may be shared, used and transmitted.

FL has recently become a popular approach to address privacy concerns by allowing collaborative training of ML models among multiple parties where each party can keep its data private.

Despite the privacy protection FL provides, there are many open problems in the FL domain, one of which is hyper-parameter optimization for FL. Existing FL systems require a user (or all participating parties) to pre-set (agree on) multiple hyper-parameters (HPs) (i) for the model being trained (such as number of layers and batch size for neural networks or tree depth and number of trees in tree ensembles), and (ii) for the aggregator (if such hyper-parameters exist).

Hyper-parameter optimization (HPO) for FL is important because the choice of HPs can have dramatic impact on performance. This is particularly important for tabular data (where datasets can be radically different from each other) as well as image data and neural nets. While HPO has been widely studied in the centralized ML setting, it comes with unique challenges in the FL setting. First, existing HPO techniques for centralized training often make use of the entire data set, which is not available in FL. Secondly, they train a vast variety of models for a large number of HP configurations which would be prohibitively expensive in terms of communication and training time in FL settings. Thirdly, one important challenge that has not been adequately explored in FL literature is support for tabular data, which are widely used in enterprise settings. One of the best models for this setting is based on gradient boosting tree algorithms, which are not based on the stochastic gradient descent training algorithm used for neural networks.

In the centralized ML setting, a model class M and a corresponding learning Algorithm A parameterized collectively with HPs θ∈Θ may be considered, and given a training set D, learn a single model [symbol] ( [symbol] , θ, D)→m∈ [symbol] can be learned. Given some predictive loss [symbol] (m, D′) of any model m scored on some holdout set D′, the centralized HPO problem can be stated as:

$${min}_{θ ∈ Θ} ℒ ( 𝒜 ( ℳ , θ , D ) , {D}^{′} ) \qquad ( 1 )$$

In the most general FL setting, p parties P₁, . . . Pₚ may exist, each with their private local training data set Dᵢ, i∈[p]. Let D=Uᵢ₌₁^{p} Dᵢ denote the aggregated training data set and D̅={Dᵢ}_{i∈[p]} denote the set of per-party data sets. Each model class (and corresponding learning algorithm) is parameterized by global HPs θ_{G}∈Θ_{G} shared by all parties and per-party local HPs θ_{L}⁽ⁱ⁾∈Θ_{L}, i∈[p] with Θ=Θ_{G}×Θ_{L}. FL systems usually include an aggregator with its own set of HPs ϕ∈Φ.

Finally, an FL algorithm [symbol] ( [symbol] , ϕ, θ_{G}, {θ_{L}⁽ⁱ⁾}_{i∈[p]}, [symbol] , D̅)→m∈ [symbol] may take as input all the relevant HPs and per-party data sets and generate a model. In this case, the FL-HPO problem can be stated in the two following ways depending on the desired goals: (i) For a global holdout data set D′ (a.k.a. validation set, possibly from the same distribution as the aggregated data set D), the following problem is solved:

$${min}_{ϕ ∈ Φ , {θ}_{G} ∈ {Θ}_{G} , {θ}_{L}^{( i )} ∈ {Θ}_{L} , i ∈ [ p ]} ℒ ( ℱ ( ℳ , ϕ , {θ}_{G} , {\{ {θ}_{L}^{( i )} \}}_{i ∈ [ p ]} , 𝒜 , \overline{D} ) , {D}^{′} ) \qquad ( 2 )$$

(ii) An alternative problem would involve per-party holdout data sets D′ᵢ, i∈[p] and the following problem is solved:

$${min}_{ϕ ∈ Φ , {θ}_{G} ∈ {Θ}_{G} , {θ}_{L}^{( i )} ∈ {Θ}_{L} , i ∈ [ p ]} Agg ( \{ ℒ ( ℱ ( ℳ , ϕ , {θ}_{G} , {\{ {θ}_{L}^{( i )} \}}_{i ∈ [ p ]} , 𝒜 , \overline{D} ) , {D}_{i}^{′} ) , i ∈ [ p ] \} ) , \qquad ( 3 )$$

where Agg: [symbol] ^{p}→ [symbol] is some aggregation function (such as average or maximum) that scalarizes the p per-party predictive losses.

Contrasting problem (1) to problems (2) & (3), the FL-HPO is significantly more complicated than the centralized HPO problem. As a result, problem (2) becomes the focus, although the single-shot FL-HPO scheme can be applied and evaluated for problem (3).

In one approach, the FL-HPO problem may be simplified in the following ways: (i) an assumption is made that there is no personalization so there are no per-party local HPs θ_{L}⁽ⁱ⁾, i∈[p], and (ii) a focus is made on the model class HPs θ_{G}. Hence the problem is updated as for a fixed aggregator HPϕ:

$${min}_{{θ}_{G} ∈ {Θ}_{G}} ℒ ( ℱ ( ℳ , ϕ , {θ}_{G} , 𝒜 , \overline{D} ) , {D}^{′} ) \qquad ( 4 )$$

This problem appears similar to the centralized HPO problem (1). However, note that the main challenge in (4) is the need for a federated training for each set of HPs θ_{G}, and hence it is not practical (from a communication overhead perspective) to apply existing off-the-shelf HPO schemes to problem (4). In the subsequent discussion, for simplicity purposes, θ will be used to denote the global HPs, dropping the “G” subscript.

### Leveraging Local HPOs

An exemplary algorithm for performing single-shot FL-HPO with federated loss surface aggregation is shown below:

FLoRA (Θ, [symbol] , {(Dᵢ, D′ᵢ)}_{i∈[p]}, T)→m
for each party Pᵢ, i∈[p]_{do}

Run HPO to generate T (HP, loss) pairs

E⁽ⁱ⁾={(θₜ⁽ⁱ⁾, [symbol] ₜ⁽ⁱ⁾), t∈[T], θₜ⁽ⁱ⁾∈Θ, [symbol] ₜ⁽ⁱ⁾:= [symbol] ( [symbol] , θₜ⁽ⁱ⁾, Dᵢ), D′ᵢ)} (5)
end
Collect all E⁽ⁱ⁾, i∈[p] in aggregator
Generate a unified loss surface [symbol] :Θ→ [symbol] using {E⁽ⁱ⁾, i∈[p]}
Select best HP candidate θ*←arg min_{θ∈Θ} [symbol] (θ)
Learn final model with federated training: m← [symbol] , ϕ, θ*, [symbol] , D̅)
return m
end

In the above scheme, each party is allowed to perform HPO locally and asynchronously with an adaptive HPO scheme such as BO. Then, at each party i∈[p], all the attempted T HPs θₜ⁽ⁱ⁾, t∈[T] and their corresponding predictive loss [symbol] ₜ⁽ⁱ⁾ are collected into a set E⁽ⁱ⁾ (line 3, equation (5)). Then these per-party sets of (HP, loss) pairs E⁽ⁱ⁾ are collected at the aggregator. This operation has at most O(pT) communication overhead (note that the number of HPs are usually much smaller than the number of columns or number of rows in the per-party data sets). These sets are then used to generate an aggregated loss surface [symbol] :Θ→ [symbol] which will then be used to make the final single-shot HP recommendation θ*∈Θ for the federated training to create the final model m∈ [symbol] .

The reason to use adaptive HPO schemes instead of non-adaptive schemes, such as random search or grid search, is that this allows us to efficiently approximate the local loss surface more accurately (and with more certainty) in regions of the HP space where the local performance is favorable instead of trying to approximate the loss surface well over the complete HP space. This has advantages both in terms of computational efficiency and loss surface approximation.

Each party executes HPO asynchronously, without coordination with HPO results from other parties or with the aggregator. This is in line with our objective to minimize communication overhead. Although there could be strategies that involve coordination between parties, they could involve many rounds of communication.

### Loss Surface Aggregation

Given the sets E⁽ⁱ⁾, i∈[p] of (HP, loss) pairs (θₜ⁽ⁱ⁾, [symbol] ₜ⁽ⁱ⁾), i∈[p], t∈[p] at the aggregator, a loss surface [symbol] : Θ→ [symbol] may be constructed that best emulates the (relative) performance loss [symbol] (74 )that would be observed when training the model on D̅.

In one approach, the loss surfaces may be modeled using regressors that try to map any HP to their corresponding loss. These loss surfaces may be constructed in the following ways:

### Single Global Model (SGM)

All the sets E⁽ⁱ⁾, i∈[p] are merged into E and used as a training set for a regressor f:Θ→ [symbol] , which considers the HPs θ∈Θ as the covariates and the corresponding loss as the dependent variable. For example, a random forest regressor may be trained on this training set E. Then the loss surface can be defined as [symbol] (θ) :=f(θ). This loss surface may end up recommending HPs that have low loss in just one of the parties.

### Single Global Model with Uncertainty (SGM+U)

Given the merged set E of the per-party sets of (HP, loss) pairs, a regressor may be trained that provides uncertainty quantification around its predictions (such as Gaussian Process Regressor) as f:Θ→ [symbol] , u:Θ→ [symbol] +, where f(θ) is the mean prediction of the model at θ∈Θ awhile u(θ) quantifies the uncertainty around this prediction f(θ). The loss surface may be defined as [symbol] (θ):=f(θ)+α·u(θ) for some scalar α>0. This loss surface may prefer HPs that have a low loss even in just one of the parties, but it penalizes a HP if the model estimates high uncertainty around this HP.

### Maximum of Per-Party Local Models (MPLM)

Instead of a single global model on the merged set E, a regressor f⁽ⁱ⁾:Θ→ [symbol] , i∈[p] may be trained with each of the per-party set E⁽ⁱ⁾, i∈[p] of (HP, loss) pairs. Given this, the loss surface may be constructed as [symbol] (θ) :=max_{i∈[p]}f⁽ⁱ⁾(θ). This can be seen as a much more pessimistic loss surface, assigning a low loss to a HP only if it has a low loss estimate across all parties.

### Average of Per-Party Local Models (APLM)

A less pessimistic version of MPLM would be to construct the loss surface as the average of the per-party regressors f⁽ⁱ⁾, i∈[p] instead of the maximum, defined as [symbol] (θ) :=1/p Σᵢ₌₁^{p}f⁽ⁱ⁾(θ). This is also less optimistic than SGM since it will assign a low loss for a HP only if its average across all per-party regressors is low, which implies that all parties observed a relatively low loss around this HP.

In one approach, a method to auto-tune hyperparameters in an FL system includes issuing, by the computing device, a hyperparameter optimization function to one or more participants in an FL scheme; receiving from the one or more participants in the FL scheme one or more features and one or more loss pairs based upon data local to each participant; selecting by the computing device one or more hyperparameters for FL training based upon the received one or more features and one or more loss pairs; and orchestrating by the computing device an FL training based upon the selected one or more hyperparameters.

As mentioned elsewhere above, machine learning is a popular means of decision making and is used in many different fields today. FL is a popular means of training machine learning models that trains a predetermined algorithm typically at a plurality of different sites that include computing devices. One goal of FL includes collaboratively training a machine learning model without sharing and/or revealing training data. Generally speaking, an amount of data that is included in such training is proportional to a relative quality of the models, e.g., relatively more data translates to relatively better quality models. However, there are downsides to including some types of data into the process of training a machine learning model. For example, including some local data such as personal data and legislation data, e.g., internet of things (IoT) data, smartphone data, General Data Protection Regulation (GDPR) data, HIPAA data, Health Insurance Portability and Accountability Act (HIPAA) data, etc., in a training process may violate data privacy laws and/or subject an associated computing device's local data to identity theft. Furthermore, including business data, e.g., cable company business strategies, banking secrets, business models, customer lists, etc., in a training process may enable competitors to gain access to such data. Some other types of data may be subject to connectivity constraints, e.g., where communication with a computing device on a different planet may take days to be performed, and therefore not be realistically feasible to incorporate into a training process.

One specific type of data that is sometimes incorporated into conventional training models includes hyperparameter (HP) data. In FL environments, HP are parameters having a value that is used to control a learning process. In an FL environment, a non-limiting group of such HPs may include, e.g., a number of total rounds such as in a global iteration, a number of clients to query for each round, etc. In contrast, a non-limiting group of local HPs such as for a party within an FL environment include, e.g., a batch size, a local learning rate, a local number of epochs, etc. Results, e.g., values, of applying HPs in a training process may be considered and adjusted, e.g., tuned, to refine an accuracy of a training process. For example, a performance metric may include any user-specified predictive performance metric, such as loss, accuracy, F1, balanced accuracy, etc. In yet another approach, HPs may include parameters used within a machine learning model during a training of the model. The selection of HPs is crucial in an FL system, especially where data distribution heterogeneity may exist among parties. However, as mentioned elsewhere above, local data such as loss performance metrics, e.g., shared HP-loss pairs, may cause a potential privacy leakage to share resulting loss of a certain HP settings in such a way that compromises the local computing device. Final HP selection in a highly heterogeneous local data distribution setting can also be affected. There is therefore a need to train a machine learning model within an FL environment without compromising the privacy of local data of a computing device.

The techniques of various approaches described herein enable HP tuning in FL settings. More specifically, such techniques include a systematic approach for causing a local party computing device to rank HP-loss pairs locally and only share the ranking results to an aggregator to perform HP tuning in an FL system. This is in contrast to sharing HP-loss pairs to perform such tuning, which would otherwise compromise local data privacy (under both independent and identically distributed (IID) and non-IID settings) of such local party computing devices. These techniques also ensure the performance of a final global model, in addition to not compromising the local data privacy of parties.

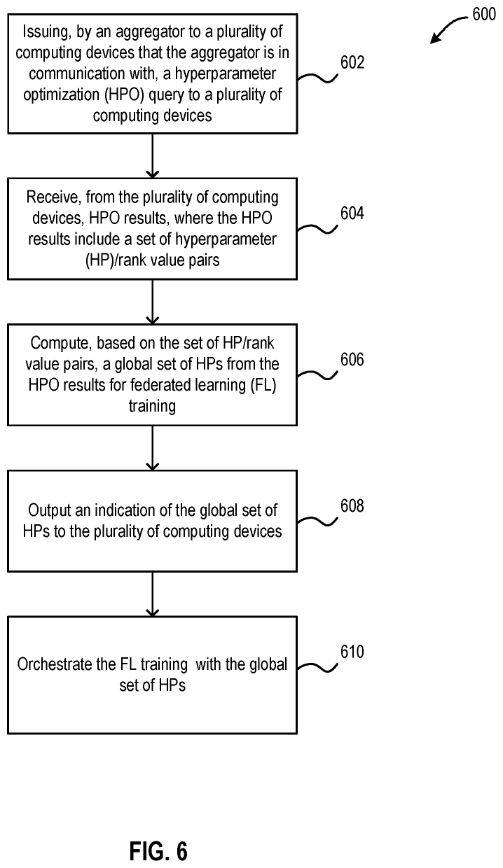

Now referring to FIG. 6, a flowchart of a method 600 is shown according to one approach. The method 600 may be performed in accordance with the present invention in any of the environments depicted in FIGS. 1-9D, among others, in various approaches. Of course, more or fewer operations than those specifically described in FIG. 6 may be included in method 600, as would be understood by one of skill in the art upon reading the present descriptions.

Each of the steps of the method 600 may be performed by any suitable component of the operating environment. For example, in various approaches, the method 600 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 600. Illustrative processors include, but are not limited to, a central processing unit (CPU), an application specific integrated circuit (ASIC), a field programmable gate array (FPGA), etc., combinations thereof, or any other suitable computing device known in the art.

Operation 602 includes issuing a HP optimization (HPO) query to a plurality of computing devices. In some preferred approaches, the HPO query is issued by an aggregator to a plurality of computing devices, e.g., a computer, a data storage system, a tier of a tiered data storage system, a memory device of a tier of a tiered data storage system, a processor, an administrator device, a cloud-based device, etc., that the aggregator is in communication with. In some approaches, each of the plurality of computing devices may include an independent hardware computing device (e.g., a server, etc.). In another approach, each of the plurality of computing devices may include a node within a distributed computing system. Additionally, in one approach, each of the plurality of computing devices may be logically and physically separate from the other computing devices. In another approach, each of the plurality of computing devices may have its own private local data set (e.g., training data). For example, the private data set of a computing device may only be assessed by that computing device, and other computing devices within the plurality of computing devices may not have access to the data set of another computing device.

In some approaches, at least some of the plurality of computing devices may each be a party within an FL environment. For example, the FL environment may include an aggregator, e.g., which may be a server, in communication with each of the plurality of computing devices. In another example, the HPO query may be sent by the aggregator to each of the plurality of computing devices. In yet another example, the aggregator may include a central node tasked with training a global model (e.g., a machine learning model such as a neural network, a decision tree, etc.). In still another example, each of the plurality of computing devices may have a corresponding local model separate from the global model.

In some approaches, at least some, and preferably each of the computing devices may have local HPs for local training on the associated computing device. Accordingly, in some approaches, the HPO query may include an instruction for the plurality of computing devices to perform HP optimization (HPO). Further still, in one approach, the HPO query may include a request to perform a plurality of HPO operations at each of the plurality of computing devices, and a performance metric to be optimized. In some approaches, performing the HPO operations may include applying a plurality of HPs to the predetermined HPO operations, where metrics such as loss is output as a result from the operations. Various examples of these HPs may include, e.g., a maximum number of iterations, a learning rate, a minimum number of samples, a number of epochs, a number of branches in a decision tree, a number of clusters in a clustering algorithm, a model architecture, a maximum number of lead nodes, a max depth, a minimum number of samples for a leaf, etc. In some approaches, each of the plurality of computing devices may perform the plurality of HPO operations in parallel, separately from the other computing devices. In another example, the performance metric of the HPO query may include one or more of predictive machine learning metrics including absolute or relative accuracy or loss and resource metrics including runtime and memory utilization. It should be prefaced however, that local performance metrics such as accuracies and/or loss are in various approaches described herein not included responses to such an HPO query. Instead, as will be described elsewhere herein, e.g., see operation 604, such performance metrics are withheld from HPO query responses and retained on the computing devices in order to prevent privacy of the local data of the computing devices from being compromised.

Operation 604 includes receiving, from at least some of the plurality of computing devices, HPO results. In some preferred approaches, the HPO results are received from each of the plurality of computing devices subsequent to the plurality of computing devices performing HPO operations to satisfy the HPO query. The HPO results, in some approaches, include a set of HP/rank value pairs, where each HP/rank value pair is associated with a different one of the computing devices. For example, in some approaches, each of the HP/rank value pairs may be generated by one of the computing devices, e.g., thereby an associated one of the computing devices, using a local dataset and a predetermined current model to run a plurality of predetermined HPO operations to fulfill the HPO query. Subsequent to running the plurality of predetermined HPO operations using the local dataset and the predetermined current model, in some approaches, at least some of the HP/rank value pairs may be generated, by an associated one of the computing devices, using a predetermined mapping function to map each local loss value resulting from running the HPO operations to a rank value. More specifically, in some approaches, the predetermined mapping function may be configured to assign ranks according to locally defined loss ranges. For example, the locally defined loss ranges may include a first predefined loss range that is a relatively lowest loss range, e.g., 0-1% of loss, 0-5% of loss, 0-10% of loss, 0-50% of loss, etc. Furthermore, the locally defined loss ranges may include at least a second predefined loss range that is a relatively highest loss range, e.g., 50-51% of loss, 50-55% of loss, 50-60% of loss, 50-100% of loss, etc. In such an example, HPs associated with operations that generate losses that fall within the first predefined range may be ranked relatively higher than HPs associated with operations that generate losses that fall within the second predefined range.

It should be noted that although some approaches described herein describe HP/rank value pairs being generated based on loss data associated with performing the HPO operations in fulfilment of the HPO query, the HP/rank value pairs may, in some approaches, additionally and/or alternatively be generated based on data of other parameter types obtained as a result of performing the HPO operations, e.g., accuracy data, runtime, memory utilization, resource consumption, etc. In one or more of such approaches, the rankings are preferably generated by mapping relatively higher ranks (for example 1^{st}, 2^{nd}, 3^{rd}, etc.) to relatively more optimal values, e.g., relatively less loss, relatively lower runtimes, relatively less resource consumption, relatively more accurate, etc., and by mapping relatively lower ranks (for example 10^{th}, 11^{th}, 12^{th}, etc.) to relatively less optimal values, e.g., relatively more loss, relatively longer runtimes, relatively more resource consumption, relatively less accurate, etc. This is beneficial because the aggregator that receives such HP/rank value pairs is able to easily differentiate and identify HPs that are relatively more optimal and furthermore HPs that are relatively less optimal. This also protects the privacy of local data by containing such data at the local level of the computing devices rather than the data being included in the HPO response.

Each of the HP/rank value pairs may in some approaches additionally and/or alternatively be generated by an associated one of the computing devices using a predetermined mapping function to map each local loss value resulting from running the HPO operations to a rank value. For example, in some approaches, method 600 includes, on each party, causing independent local HPOs to be run to generate a set of (HP, loss) pairs. The loss of such pairs may be mapped to a rank value to obtain the HP/rank value pairs. In some approaches, the mapping function may be configured to map a loss to a rank value with a predefined range for each rank. In at least some of such approaches, the mapping function may be configured to assign ranks according to global pre-defined loss ranges. The global pre-defined loss ranges may in some approaches be indicated to at least some of the computing devices in the HPO query. This way, each of the HPO results that are received, e.g., by the aggregator, may include values, e.g., values of the (HP)/rank value pairs, that are relative to one another.

It should be noted that the HP/rank value pairs preferably do not include local value data of the computing devices. For example, in some approaches, the HP/rank value pairs preferably do not include accuracy values, e.g., other than the HP/rank value pairs that are generated using such local data. In another example, the HP/rank value pairs preferably do not include loss values, e.g., other than the HP/rank value pairs that are generated using such local data. In yet another example, in some approaches, the HP/rank value pairs preferably do not include resource metric values such as runtime utilization values, e.g., other than the HP/rank value pairs that are generated using such local data. In another example, in some approaches, the HP/rank value pairs preferably do not include resource metric values such as memory utilization values, e.g., other than the HP/rank value pairs that are generated using such local data.

Several benefits are enabled as a result of using the techniques described above to generate and receive the HP/rank value pairs as opposed to local data being otherwise received by the aggregator. This is because intentionally excluding such local data from the HP/rank value pairs ensures that such local data, e.g., such as loss data, is not shared in a setting that compromises the security and privacy of such data. This setting may include the aggregator and/or during transmission to the aggregator. Outside actors, e.g., such as a competitor capable of reverse engineering the data, a malicious actor capable of using the data to gain unauthorized access to the computing device, etc., may be able to intercept such local data if such data is otherwise shared outside of the local setting of the computing devices. Note that the HP/rank value pairs do not prevent HP tuning from being performed. In sharp contrast, as will be described in greater detail elsewhere below, while locally retaining and concealing local data, the HP/rank value pairs outperform default HP performance that is based on FL implementations where local data is made available outside of the computing devices.

Operation 606 includes computing, based on the set of HP/rank value pairs, a global set of HPs from the received HPO results for federated learning (FL) training. For context, the global set of HPs may be at least one optimal HP of the HP/rank value pairs that is determined by the aggregator to relatively improve performance of computing devices with respect to losses, e.g., relatively reduce losses when used to perform HPO operations. In some other approaches, the global set of HPs may not be from the set of HP/rank value pairs used to train a model that computes the global set of HPs. Various techniques that may be used to compute the global set of HPs are described below in accordance with one or more approaches.

In some preferred approaches, computing the global set of HPs, e.g., optimal global HPs, from the HPO results for federated learning (FL) training may include generating a unified loss surface using a union of all the HP/rank value pairs of the received HPO results from each of the plurality of computing devices. Accordingly, generating the unified loss surface using the HP/rank value pairs may map each of the HPs of the value pairs to a rank. In some approaches, the unified loss surface may be a classifier of a type that would become apparent to one of ordinary skill in the art upon reading the descriptions herein. In some other approaches, the unified loss surface may be a regressor of a type that would become apparent to one of ordinary skill in the art upon reading the descriptions herein. The union may combine all of the received HPO results (e.g., HP/rank value pairs from all of the computing devices) into a single set of HP/rank value pairs. The unified loss surface may be generated by training a predetermined machine learning model in some approaches. For example, the aggregator may compute a union of the collected HP/rank value pairs and train a regression and/or classification model, e.g., also known as loss surface, based on the collected HP/rank value pairs. More specifically, in some preferred approaches, training the predetermined machine learning model includes using the HPs of the HP/rank value pairs as inputs of the predetermined machine learning model. Furthermore, in some approaches, the ranks of the HP/rank value pairs may additionally and/or alternatively be used as targets of the predetermined machine learning model during the training of the predetermined machine learning model. Note that the ranks used for the targets may correspond to the HP that are used as in input in that iteration of the training. In some other approaches, the aggregator may perform the union of the HPO results, and may generate the unified loss surface.

The trained predetermined machine learning model is in some preferred approaches a loss surface model that is used to compute the set of global hyperparameters. In some approaches, the aggregator computes the global HPs based on the regression model such that the HPs of the global set give the relatively best rank result. The global HPs computed for the global set of HPs may be determined utilizing the unified performance metric surface. In some approaches, the global set of HPs may be computed via minimizing a predetermined unified loss surface function of the unified loss surface. In one approach, for each HP value in the union of the HPO results, a prediction may be determined utilizing the trained predetermined machine learning model to determine a loss value for that HP. In one approach, this minimizing may be performed using results of the trained predetermined machine learning model. In one preferred approach, a single HP that minimizes this loss surface may be used as the global set of HPs. In another approach, HPs of HP/rank value pairs having at least a predetermined rank may be determined to be optimal global HPs for the global set of HPs.

Operation 608 includes outputting an indication of the global set of HPs to the plurality of computing devices. Outputting such an indication preferably shares the global set of HPs with the plurality of computing devices. Accordingly, in some approaches, the output indication indicates a name of the HPs. In some approaches, outputting merely the name(s) of the HPs of the global set of HPs enables a relatively low bandwidth operation which preserves processing potential of the aggregator and the receiving computing devices. In contrast, in some other approaches, the output indication indicates detailed information about characteristics of the HPs and how to apply such HPs in HPO operations.

The output indication of the global set of HPs to the computing devices enables HPs determined to be optimal to be utilized on the computing devices at the party sites.

Further still, in one approach, the aggregator may ongoingly send queries to each of the computing devices. For example, the queries may request updated HPO results from each of the parties, where the updated HPO results include updated (HP)/rank value pairs. In another approach, the aggregator may receive replies from the parties in response to the queries, may aggregate the replies, may generate results based on the aggregation, and may update the global model, based on the results. In this way, optimal HPs may be dynamically determined for the global model and then reiterated to each of the computing devices. This ensures that the relative performance increases enabled as result of utilizing the techniques of one or more of the approaches described herein, continue to be realized and refined. This reduces the amount of processing that would otherwise be necessary to fine-tune the global model during FL, which translates to a relatively improved performance of computing hardware performing the FL (e.g., the aggregator, etc.).

Operation 610 includes orchestrating the FL training, e.g., issuing instructions to use the global set of HPs over other HPs. The FL training is preferably orchestrated to be performed with the global set of HPs. In one preferred approach, orchestrating the FL training includes executing single federated training with the global set of HPs. Furthermore, in some preferred approaches, the FL training is preferably orchestrated to be performed globally by the aggregator using the global set of HPs and/or locally by the computing devices.

Various benefits are enabled as a result of utilizing the techniques described herein to compute and use HPs without revealing local data to an aggregator outside of the computing devices. For example, by computing and orchestrating the global sets of HPs, HPs tuning is performed to prioritize HPs associated with a relatively least amount of loss. This results in performance benefits because HPs associated with relatively more loss are tuned out from the FL environment, while HPs associated with relatively less loss are tuned to be prioritized in the FL environment. Furthermore, in the process of performing this tuning, local data of the computing devices remains protected and not exposed to an actor that could otherwise potentially compromise the computing devices using the local data.

These benefits are particularly useful for any company that wants to use or offer cognitive solutions where training data remains with the user, e.g., such as search engine based companies, communication device companies, device program companies, online sales companies, social media companies, companies that want to use IoT to train prediction models, etc. These techniques are furthermore applicable for highly regulated environments such as healthcare, the banking industry, where competition may inhibit the free sharing of data, companies subject to GDPR and HIPAA laws, consortiums that want to learn a collaborative model without sharing their data.

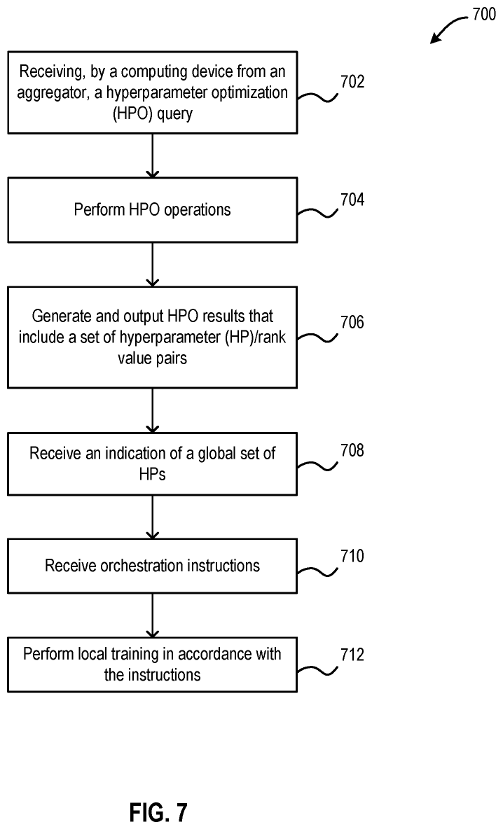

It should be noted that various operations of method 600 are described from the perspective other than the computing devices. Referring now to FIG. 7, various illustrative operations that may be performed from the perspective of a computing device are described in one approach.

Now referring to FIG. 7, a flowchart of a method 700 is shown according to one approach. The method 700 may be performed in accordance with the present invention in any of the environments depicted in FIGS. 1-9D, among others, in various approaches. Of course, more or fewer operations than those specifically described in FIG. 7 may be included in method 700, as would be understood by one of skill in the art upon reading the present descriptions.

Each of the steps of the method 700 may be performed by any suitable component of the operating environment. For example, in various approaches, the method 700 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 700. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 700 includes operations which may be performed by a computing device that is in communication with an aggregator. In some approaches, the aggregator may be in communication with a plurality of computing devices, e.g., parties, and therefore the operations of method 700 may optionally be performed simultaneously by each of a plurality of computing devices in some approaches.

Operation 702 includes receiving a HPO query. The HPO query may be received by a computing device from an aggregator that is in communication with the computing device. The received HPO query may request that the communication device perform at least some HPO operations. Accordingly, in response to receiving the HPO query, the computing device may perform HPO operations, e.g., see operation 704. In some approaches, performing the HPO operations may include applying a plurality of HPs to the predetermined HPO operations, where metrics such as loss is output as a result from the operations. Various examples of these HPs may include, e.g., a maximum number of iterations, a learning rate, a minimum number of samples, a number of epochs, a number of branches in a decision tree, a number of clusters in a clustering algorithm, a model architecture, etc.

Subsequent to performing at least some of the HPO operations, the computing device may generate and output, e.g., to the aggregator, HPO results that include a set of HP/rank value pairs, e.g., see operation 706. Each computing device receiving the HPO query may in response thereto use a local dataset and a current model to run HPO operations to generate a set of features/loss pairs. Techniques described elsewhere herein for generating the value pairs may additionally and/or alternatively be modified to be used in operation 706. It should be noted that local information of the computing device is preferably not included in the HP/rank value pairs output to the aggregator. This would otherwise compromise the security and privacy of the local information. Accordingly, by generating and outputting HP/rank value pairs to the aggregator for tuning HPs in an FL environment, local data of computing devices is not jeopardized by potentially harmful outside actors.

The aggregator may compute a global set of HPs based on the HPO results, and an indication of the global set of HPs may be received by the computing devices, e.g., see operation 708.

Orchestration instructions may be received, e.g., see operation 710. FL training may be performed by the computing devices in accordance with the orchestration instructions using the global set of HPs in response to receiving the orchestration instructions, e.g., see operation 712.

Similar benefits described elsewhere above with respect to method 600 are also enabled as a result of utilizing the techniques described in various operations of method 700. For example, by computing and outputting (HP)/rank value pairs that do not include local data such as loss data, performance data, etc., local data of the computing device remains protected and not exposed to an actor that could otherwise potentially compromise the computing devices using the local data. Performance of training that is performed in a FL environment that includes the computing device is relatively higher than a performance that would otherwise be experienced in the event that a non-minimizer of the loss surface is used as the global set of HPs that is ultimately used for training.

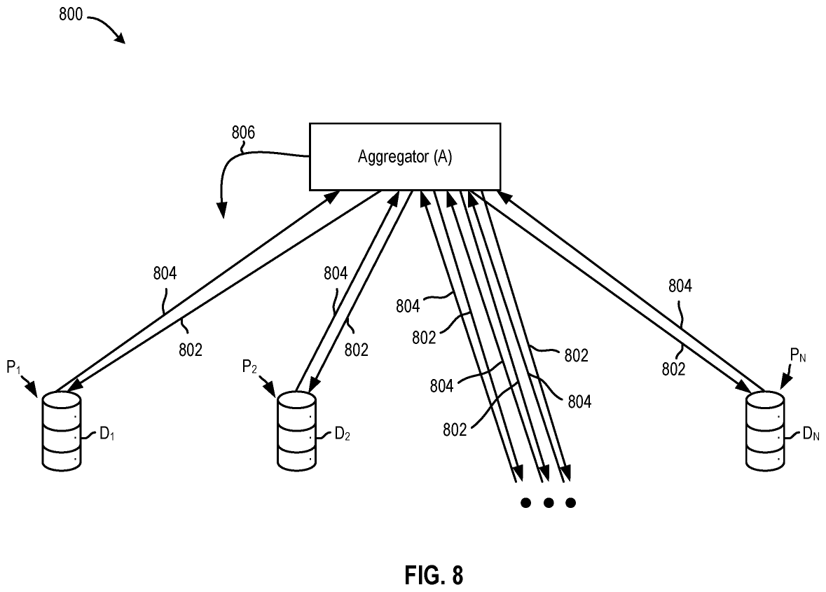

FIG. 8 depicts a FL environment 800, in accordance with one approach. As an option, the present FL environment 800 may be implemented in conjunction with features from any other approach listed herein, such as those described with reference to the other FIGS. Of course, however, such FL environment 800 and others presented herein may be used in various applications and/or in permutations which may or may not be specifically described in the illustrative approaches listed herein. Further, the FL environment 800 presented herein may be used in any desired environment.

The FL environment 800 includes an aggregator, e.g., A, that is in communication with a plurality of different parties, e.g., see P₁, P₂, . . . , P_{N}, which each be a computing device that includes a local database, e.g., see D₁, D₂, . . . , P_{N}.

An HPO query 802 is issued by the aggregator to the plurality of parties. In some approaches, the query may be issued to the plurality of parties simultaneously, e.g., a broadcast. In some other approaches, a query may be issued to each of the plurality of parties independently, e.g., a plurality of queries each issued to a different one of the parties.

In response to receiving the HPO query, the parties may perform predetermined HPO operations. For example, the parties may run a predetermined HPO algorithm, e.g., random search, Bayesian based optimization, etc.

From the results of running the predetermined HPO operations, the parties may map each loss value to a rank value. For example, a set of ranked values (Eᵢ) may be generated by each of the parties from the predetermined HPO algorithm and a predetermined mapping function, e.g., E₁=map(HP0 (Dᵢ, θ_{G}, θ_{L})), E₂=map(HPO(D₂, θ_{G}, θ_{L})), . . . , E_{N}=map(HPO(D_{N}, θ_{G}, θ_{L})). Here θ_{G} and θ_{L} are sets of candidate global HPs and local HPs generating based on random sampling or Bayesian algorithm depending on the specific HPO algorithm. The results of performing the HPO operations may include loss values, e.g., HPO: (Dᵢ, θ_{G}, θ_{L})→loss, and therefore the predetermined mapping function may be used to map such losses to rank values to establish HP/rank value pairs, e.g., map: loss→rank value.

The parties may share the resulting HP/rank value pairs, e.g., R₁=(θ_{G}¹, θ_{L}¹, E₁), R₂=(θ_{G}², θ_{L}², E₂), . . . , R_{N}=(θ_{G}^{N}, θ_{L}^{N}, E_{N}), with the aggregator, e.g., see operation 804.

HPO results are received from each of the plurality of parties. The HPO results include a set of hyperparameter (HP)/rank value pairs where each HP/rank value pair is associated with a different one of the parties. The aggregator computes a union of the collected HP/rank pairs, e.g., M: Composition of R₁, R₂, . . . , P_{N}, and may train a regression/classification model, e.g., also known as a loss surface, based on these pairs.

A global set of HPs is computed based on the set of HP/rank value pairs for federated learning (FL) training. For example, the aggregator may compute the optimal global HPs based on a predetermined regression model such that the selected HPs provide a relatively best rank result.

An indication of the global set of HPs may be output to the plurality of parties to share the global set of HPs with the parties, e.g., see operation 806.

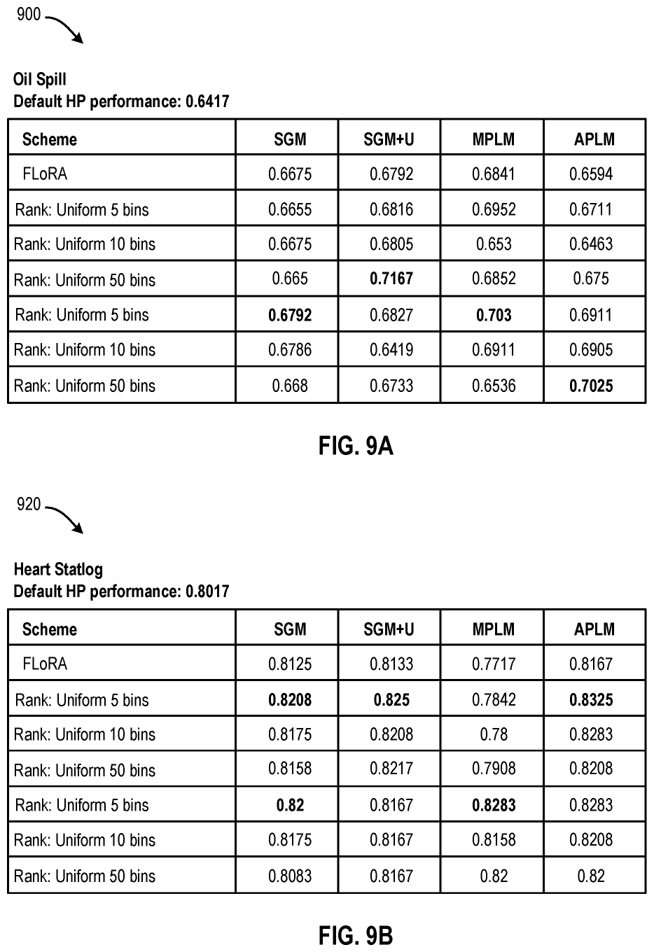

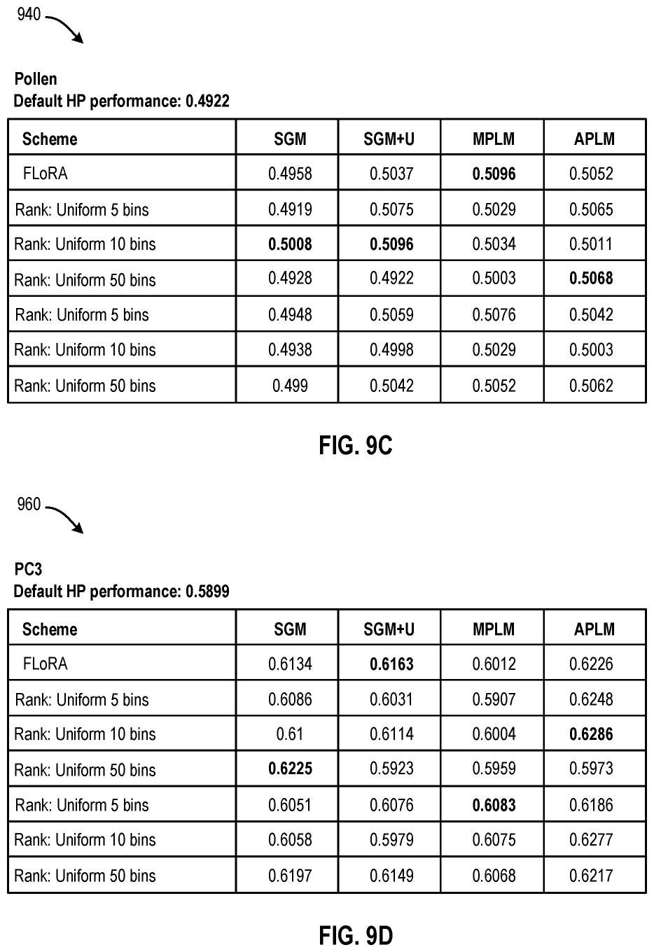

FIGS. 9A-9D depict tables 900, 920, 940, 960 of preliminary experimental results, in accordance with various approaches. As an option, the present tables 900, 920, 940, 960 may be implemented in conjunction with features from any other approach listed herein, such as those described with reference to the other FIGS. Of course, however, such tables 900, 920, 940, 960 and others presented herein may be used in various applications and/or in permutations which may or may not be specifically described in the illustrative approaches listed herein. Further, the tables 900, 920, 940, 960 presented herein may be used in any desired environment.

It may be prefaced that tables 900, 920, 940, 960 illustrate experimental results generated by a model that includes gradient boosted decision trees. Furthermore, a metric of the model includes balanced accuracy, and data of the model includes four datasets from OpenML that are each based on different scenarios, e.g., see oil spill, heart statlog, pollen and PC3. Finally, FL settings of the model include three parties for each experiment, e.g., where the data is divided equally and randomly.

Referring first to FIG. 9A, the table 900 includes a plurality of schemes that each represent HP/rank value pairs. For example, in the scheme “Rank: Uniform 5 bins,” rank values may be assigned to five different bins. These assignments may be based on predetermined performance metrics that result from use of the HPs in HPO operations for satisfying an HPO request. For example, assuming that the predetermined performance metric is accuracy, assignment to each of the five bins may include assigning HPs having an accuracy in a top twentieth percentile in a first bin having a relatively highest rank, e.g., first, assigning HPs having an accuracy in the 21^{st}-40th percentile in a second bin having a relatively second highest rank, e.g., second, assigning HPs having an accuracy in the 41^{st}-60th percentile in a third bin having a relatively third highest rank, e.g., third, assigning HPs having an accuracy in the 61^{st}-80th percentile in a fourth bin having a relatively fourth highest rank, e.g., fourth, and assigning HPs having an accuracy in the 81^{st}-100th percentile in a fifth bin having a relatively fifth highest rank, e.g., fifth. Similar rankings may be utilized in the other schemes, e.g., HPs may be ranked into ten different bins for “Rank: Uniform 10 bins,” HPs may be ranked into fifty different bins for “Rank: Uniform 50 bins,” etc. It should be noted that the more bins that are utilized, the more accurate the information provided to the aggregator will be. This is because the ranking of HPs will be relatively more detailed in approaches that utilize relatively more bins. The scheme also includes a FLoRA row that illustrates accuracies associated with using types of value pairs described elsewhere herein, e.g., see FIG. 3.

These accuracies used to perform the ranking may be considered with respect to a plurality of different loss surfaces, e.g., see semi-global matching (SGM), semi-global matching with uncertainty (SGM+U), maximum of per-party local models (MPLM), and average of per-party local models (APLM). More specifically, these accuracies are the result of an optimal global HP being computed by the aggregator from the HP/rank value pairs and applied. It should be noted that each of such loss surface columns includes a bolded accuracy performance value which notes a relatively highest performing HP/rank value pair ranking.

It should also be noted that HP performance is not lost as a result of not including local data in the HP/rank value pairs provided to the aggregator. In sharp contrast, performance achieved in the model by using HP/rank value pairs instead of disclosing local data to the aggregator exceeded default HP performances across each of the loss surfaces. For example, in the table 900 of FIG. 9A, the default HP performance of 0.6417 is exceeded by at least a relatively highest performance metric in the SGM loss surface column, e.g., see 0.6792, the default HP performance of 0.6417 is exceeded by at least a relatively highest performance metric in the SGM+U loss surface column, e.g., see 0.7167, the default HP performance of 0.6417 is exceeded by at least a relatively highest performance metric in the MPLM loss surface column, e.g., see 0.703, and the default HP performance of 0.6417 is exceeded by at least a relatively highest performance metric in the APLM loss surface column, e.g., see 0.7025.

Furthermore, referring now to the table 920 of FIG. 9B, the default HP performance of 0.8017 is exceeded by at least a relatively highest performance metric in the SGM loss surface column, e.g., see 0.8208, the default HP performance of 0.8017 is exceeded by at least a relatively highest performance metric in the SGM+U loss surface column, e.g., see 0.825, the default HP performance of 0.8017 is exceeded by at least a relatively highest performance metric in the MPLM loss surface column, e.g., see 0.8283, and the default HP performance of 0.8017 is exceeded by at least a relatively highest performance metric in the APLM loss surface column, e.g., see 0.8325.

Furthermore, referring now to the table 940 of FIG. 9C, the default HP performance of 0.4922 is exceeded by at least a relatively highest performance metric in the SGM loss surface column, e.g., see 0.5008, the default HP performance of 0.4922 is exceeded by at least a relatively highest performance metric in the SGM+U loss surface column, e.g., see 0.5096, and the default HP performance of 0.4922 is exceeded by at least a relatively highest performance metric in the APLM loss surface column, e.g., see 0.5068.

Furthermore, referring now to the table 960 of FIG. 9D, the default HP performance of 0.5899 is exceeded by at least a relatively highest performance metric in the SGM loss surface column, e.g., see 0.6225, the default HP performance of 0.5899 is exceeded by at least a relatively highest performance metric in the MPLM loss surface column, e.g., see 0.6083, and the default HP performance of 0.5899 is exceeded by at least a relatively highest performance metric in the APLM loss surface column, e.g., see 0.6286.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A computer-implemented method, comprising:
issuing a hyperparameter optimization (HPO) query to a plurality of computing devices;
receiving, from the plurality of computing devices, HPO results, wherein the HPO results include a set of hyperparameter (HP)/rank value pairs;
computing, based on the set of HP/rank value pairs, a global set of HPs from the HPO results for federated learning (FL) training; and
outputting an indication of the global set of HPs to the plurality of computing devices.

2. The computer-implemented method of claim 1, comprising: orchestrating the FL training with the global set of HPs.

3. The computer-implemented method of claim 1, wherein computing, based on the set of HP/rank value pairs, the global set of HPs from the HPO results for federated learning (FL) training includes generating a unified loss surface using the HP/rank value pairs of the received HPO results, wherein a minimizer of a predetermined unified loss surface function is the global set of HPs.

4. The computer-implemented method of claim 3, wherein the unified loss surface is generated by training a predetermined machine learning model, wherein the HPs of the HP/rank value pairs are used as inputs of the predetermined machine learning model, wherein the ranks of the HP/rank value pairs are used as targets of the predetermined machine learning model.

5. The computer-implemented method of claim 4, wherein the trained predetermined machine learning model is a loss surface model that is used to compute the set of global hyperparameters.

6. The computer-implemented method of claim 1, wherein each of the HP/rank value pairs are generated, by an associated one of the computing devices, using a local dataset and a current model to run a plurality of HPO operations.

7. The computer-implemented method of claim 6, wherein each of the HP/rank value pairs are generated, by an associated one of the computing devices, using a predetermined mapping function to map each local loss value resulting from running the HPO operations to a rank value, wherein the predetermined mapping function is configured to assign ranks according to locally defined loss ranges.

8. The computer-implemented method of claim 6, wherein each of the HP/rank value pairs are generated, by an associated one of the computing devices, using a predetermined mapping function to map each local loss value resulting from running the HPO operations to a rank value, wherein the predetermined mapping function is configured to assign ranks according to global pre-defined loss ranges.

9. The computer-implemented method of claim 1, wherein each of the plurality of computing devices includes a party within a federated learning environment.

10. A computer program product, the computer program product comprising a computer readable storage medium having program instructions embodied therewith, the program instructions readable and/or executable by a computer to cause the computer to:
issue, by the computer, a hyperparameter optimization (HPO) query to a plurality of computing devices;
receive, by the computer, from the plurality of computing devices, HPO results, wherein the HPO results include a set of hyperparameter (HP)/rank value pairs;
compute, by the computer, based on the set of HP/rank value pairs, a global set of HPs from the HPO results for federated learning (FL) training; and
output, by the computer, an indication of the global set of HPs to the plurality of computing devices.

11. The computer program product of claim 10, the program instructions readable and/or executable by the computer to cause the computer to: orchestrate, by the computer, the FL training with the global set of HPs.

12. The computer program product of claim 10, wherein computing, based on the set of HP/rank value pairs, the global set of HPs from the HPO results for federated learning (FL) training includes generating a unified loss surface using the HP/rank value pairs of the received HPO results, wherein a minimizer of a predetermined unified loss surface function is the global set of HPs.

13. The computer program product of claim 12, wherein the unified loss surface is generated by training a predetermined machine learning model, wherein the HPs of the HP/rank value pairs are used as inputs of the predetermined machine learning model, wherein the ranks of the HP/rank value pairs are used as targets of the predetermined machine learning model.

14. The computer program product of claim 13, wherein the trained predetermined machine learning model is a loss surface model that is used to compute the set of global hyperparameters.

15. The computer program product of claim 10, wherein each of the HP/rank value pairs are generated, by an associated one of the computing devices, using a local dataset and a current model to run a plurality of HPO operations.

16. The computer program product of claim 15, wherein each of the HP/rank value pairs are generated, by an associated one of the computing devices, using a predetermined mapping function to map each local loss value resulting from running the HPO operations to a rank value, wherein the predetermined mapping function is configured to assign ranks according to locally defined loss ranges.

17. The computer program product of claim 15, wherein each of the HP/rank value pairs are generated, by an associated one of the computing devices, using a predetermined mapping function to map each local loss value resulting from running the HPO operations to a rank value, wherein the predetermined mapping function is configured to assign ranks according to global pre-defined loss ranges.

18. The computer program product of claim 10, wherein each of the plurality of computing devices includes a party within a federated learning environment.

19. A system, comprising:
a processor; and
logic integrated with the processor, executable by the processor, or integrated with and executable by the processor, the logic being configured to:
issue a hyperparameter optimization (HPO) query to a plurality of computing devices;
receive, from the plurality of computing devices, HPO results, wherein the HPO results include a set of hyperparameter (HP)/rank value pairs;
compute, based on the set of HP/rank value pairs, a global set of HPs from the HPO results for federated learning (FL) training; and
output an indication of the global set of HPs to the plurality of computing devices.

20. The system of claim 19, the logic being configured to: orchestrate the FL training with the global set of HPs.
